(19) United States
(12) Patent Application Publication
(10) Pub. No.: US 2013/0231933 A1
(43) Pub. Date: Sep. 5, 2013

(54) Addressee Identification of Speech in Small Groups of Children and Adults

(71) Applicants: Hannaneh Hajishirzi, Pittsburgh, PA (US); Jill Fain Lehman, Pittsburgh, PA (US)

(72) Inventors: Hannaneh Hajishirzi, Pittsburgh, PA (US); Jill Fain Lehman, Pittsburgh, PA (US)

(73) Assignee: DISNEY ENTERPRISES, INC., Burbank, CA (US)

(21) Appl. No.: 13/411,380

(22) Filed: Mar. 2, 2012

(51) Int. Cl. G10L 17/00

(52) U.S. Cl. 704/246; 704/E17.001

(57) ABSTRACT

A method and system for assignee identification of speech includes defining several time intervals and utilizing one or more function evaluations to classify each of the several participants as addressing speech to an automated character or not addressing speech to the automated character during each of the several time intervals. A first function evaluation includes computing values for a predetermined set of features for each of the participants during a particular time interval and assigning a first addressing status to each of the several participants in the particular time interval, based on the values of each of the predetermined sets of features determined during the particular time interval. A second function evaluation may assign a second addressing status to each of the several participants in the particular time interval utilizing results of the first function evaluation for the particular time interval and for one or more additional contiguous time intervals.

### BACKGROUND

Interactions between computer-controlled animated or robotic characters and people are becoming more common. However, to facilitate such interactions, it is necessary to identify when a participant in an interactive game, for example, is speaking to the character versus simply communicating to another participant. Current approaches have focused on the interactions with groups of adults. However, interactions commonly take place between computer-controlled animated or robotic characters and small groups of children. Current approaches based on adult data do not effectively translate to children, particularly young children, due to their limited mastery of language and social conventions, their limited knowledge of the world, cognitive processing speed, consistent use of gestures, as well as their inability to stand still, for example. Furthermore, current approaches based on data from modeling adult tasks, such as meetings around a table or dyads around an information kiosk, do not effectively translate to multi-participant game environments.

### SUMMARY

The present application is directed to addressee identification of speech in small groups of children and adults, substantially as shown in and/or described in connection with at least one of the figures, and as set forth more completely in the claims.

### BRIEF DESCRIPTION OF THE DRAWINGS

FIG. 1 illustrates an exemplary diagram of a system for addressee identification of speech, according to one implementation of the present application.

FIG. 2 presents an exemplary flowchart describing a method for addressee identification of speech, according to one implementation of the present application.

FIG. 3 illustrates an exemplary diagram of a plurality of defined time intervals for addressee identification of speech, according to one implementation of the present application.

FIG. 4 presents an exemplary diagram describing a first function evaluation of a method for addressee identification of speech, according to one implementation of the present application.

FIG. 5 presents an exemplary diagram describing a second function evaluation of a method for addressee identification of speech, according to one implementation of the present application.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

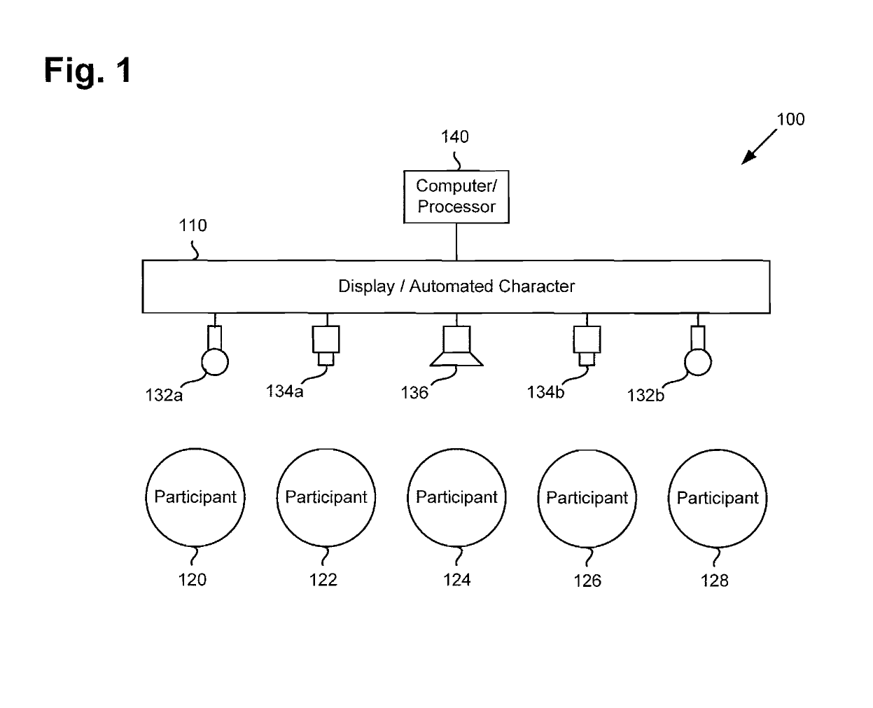

FIG. 1 illustrates an exemplary diagram of system 100 for addressee identification of speech, according to one implementation of the present application. System 100 may include an automated character 110, which may be a computer-controlled animated character on a display or a computer-controlled robot, for example. System 100 may further include speaker 136, which may be configured to project character speech or sound effects for the purpose of prompting a response from one of several participants or to generally facilitate interaction with the participants. Exemplary system 100 may also include video capture devices 134a and 134b, which may be configured to capture video data of each of participants 120, 122, 124, 126 and 128 during interaction with automated character 110. For the purposes of the present application, participants 120, 122, 124, 126 and 128 may be young children, for example, between 4 and 10 years old. However, the participants are not limited in this respect and the participants may be of any age. Video capture devices 134a and 134b may each represent a single video capture device, or in the alternative, each may represent a plurality of video capture devices. Microphones 132a and 132b may be configured to capture audio data from one or more of participants 120, 122, 124, 126 and 128 during interaction with automated character 110, for example. Each of microphones 132a and 132b may be a close-talk microphone, a linear microphone array collocated with the display, or any other type of microphone. Processor 140 may have one or more circuits configured to generate or receive audio and video data, as well as control system 100, in accordance with one or more methods disclosed in the present application.

Within system 100, participants 120, 122, 124, 126 and 128 may interact with automated character 110 through greetings, responses to yes/no questions, or referring phrases choosing from several objects, which may be presented to the participants on a display or spoken to the participants by automated character 110, for example. The participants may interact with the automated character through gestures such as head shake yes, head shake no, pointing gestures or emphasis gestures, for example, and through head movements such as head turn away, head turn back or head incline, for example. Such head movements may be determined with respect to automated character 110 or, in the alternative, may be determined with respect to another one of the participants, for example. Audio and video data of the participants, captured by one or more of microphones 132a and 132b and one or more of video capture devices 134a and 134b, may be utilized to recognize when speech from one of the participants is directed to an automated character, and utilize that speech to advance a game or presentation within the system, for example.

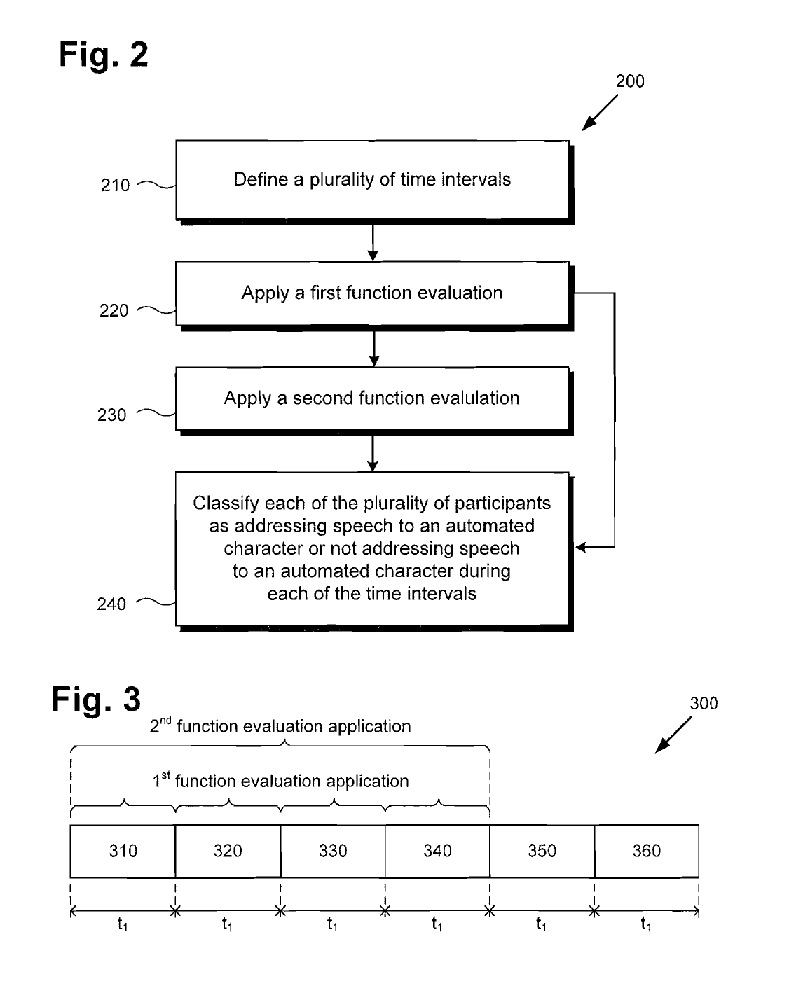

The operation of the system disclosed in FIG. 1 will now be further described by reference to FIGS. 2 and 3. FIG. 2 presents an exemplary flowchart describing a method for addressee identification of speech, according to one implementation of the present application. FIG. 3 illustrates an exemplary diagram of a plurality of defined time intervals for addressee identification of speech, according to one implementation of the present application.

In the present application, the task of automatically identifying whether speech from a participant is directed to an automated character is approached as a non-probabilistic binary classification task. That is, the methods disclosed herein attempt to definitively classify speech as either character-directed or non-character-directed speech, rather than assigning probabilities to the likelihood of a segment of speech being properly classified as one or the other. The present application contemplates a machine learning approach utilizing a support vector machine (SVM), for example. However, the present application is not limited to a SVM approach, but may encompass any other suitable non-probabilistic approach.

Action 210 of flowchart 200 includes defining a plurality of time intervals. In each implementation of the present application, each participant's participation is divided into a plurality of equal-duration time intervals. Such division is illustrated by FIG. 3, which shows an exemplary timeline 300 of a participant's participation in system 100, for example. Each of the plurality of time intervals 310 through 360 may have a duration of t₁, which may be 500 milliseconds, for example. However, the duration t₁ is not limited to 500 milliseconds, and may be any suitable duration. In addition, the number of time intervals is not limited to those shown in FIG. 3.

A first function evaluation may then be applied to each of a plurality of participants during each of the time intervals in succession. Action 220 of flowchart 200 includes applying a first function evaluation. According to the implementation shown in

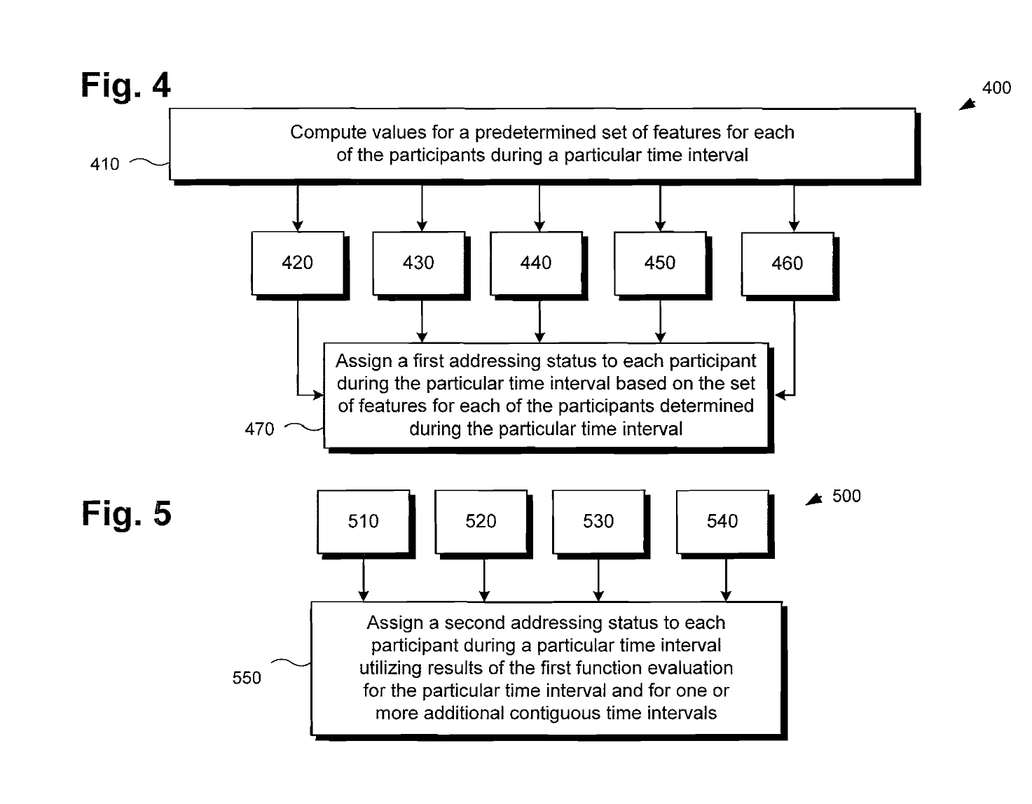

FIG. 1, for example, processor 140 may have one or more circuits configured to apply the first function evaluation to each of the plurality of participants during each of the plurality of time intervals in succession. Such intervals are illustrated as time intervals 310 through 360 of FIG. 3, for example. The application of the first function evaluation as illustrated by action 220 of flowchart 200 will now be further described by reference to FIG. 4.

FIG. 4 presents an exemplary diagram describing a first function evaluation of a method for addressee identification of speech, according to one implementation of the present application. In determining whether speech from a participant occurring in a particular time interval is directed to an automated character, a first function evaluation utilizes data from only that particular time interval to assign a first addressing status indicating whether each participant is directing speech, during that particular time interval, to the automated character. This first function evaluation may be based on a predetermined set of features for each of the several participants during a particular time interval. Such a predetermined set of features may include several determinations, as outlined by actions 420 through 460 of diagram 400. Each of the determinations made in a given set of features may be calculated in parallel with one another. Thus, the determination of a set of features may be, but is not necessarily, a serial process.

Action 410 of diagram 400 includes computing values for a predetermined set of features for each of the participants during a particular time interval. Depending on the game environment or nature of a presentation with which participants interact, the specific features within a set of features, which may be optimal for assignee identification of speech, may not always be the same. Thus, different implementations may include predetermined feature sets having one or more of the exemplary features determined by actions 420 through 460. However, the present inventive concepts are not limited to the features of actions 420 through 460, but may include any additional features which may be useful for addressee identification of speech, for example.

Action 420 of diagram 400 includes a determination of whether the particular participant, for which the set of features is being determined, is speaking during the particular time interval. According to the implementation shown in FIG. 1, for example, speech from any of participants 120, 122, 124, 126 or 128 may be received by microphones 132a and/or 132b, while video data of the participants may be received by video capture devices 134a and/or 134b. The captured speech and video data may be routed to processor 140, which may have one or more circuits configured to make the determination of action 420. Such a determination may be made independent of the content of the participant speech.

Whether an automated character has generated speech or sound effects which would prompt a participant to respond during a particular time interval, may have an effect on whether participant speech during the interval is directed to the automated character. Action 430 of diagram 400 includes determining whether the automated character prompted for a response from the plurality of participants during the particular time interval. Such prompts may include speech or sound effects from the automated character, for example. According to the implementation shown in FIG. 1, for example, processor 140 may have one or more circuits configured to make the determination of action 430.

The gestures or head movements of a particular participant may also have an effect on whether participant speech is directed to the automated character rather than another participant, for example. Action 440 of diagram 400 includes determining whether gestures or head movements of the particular participant, for which the set of features is being determined, are present during the particular time interval. According to the implementation shown in FIG. 1, for example, video data regarding gestures and/or head movements of each of participants 120, 122, 124, 126 and 128 may be captured by video capture device 134a and/or 134b. The captured video data may be routed to processor 140, which may have one or more circuits configured to make the determination of action 440. Examples of determinable gestures may include a head shake yes, a head shake no, pointing gestures, and emphasis gestures. Examples of determinable head movements may include head turn away from the automated character, head turn toward the automated character, and an incline of the head. However, such gestures and/or head movements are not limited to these examples and may include any gestures and/or head movements which may be useful in addressee identification of participant speech.

Continuing with action 450 of diagram 400, action 450 includes determining a pitch of the participant speech and a volume of the participant speech, each averaged over the particular time interval. According to the implementation shown in FIG. 1, for example, speech from any of participants 120, 122, 124, 126 or 128 may be received by microphones 132a and/or 132b. The received speech may be routed to processor 140, which may have one or more circuits configured to make the determinations of action 450.

Action 460 of diagram 400 includes determining whether the participant speech includes one or more discourse markers, utilizing speech recognition. The discourse markers may include task-independent words such as “um”, “ok”, “who”, “what”, “when”, “where”, “why” and words having equivalent meanings in English. For example, and without limitation, the word “urn” may also include words such as “ah”, “hmm” and “huh” while the word “ok” may also include words such as “yes”, “yeah” and “uh huh”. Such words and their variations may additionally apply to non-English languages and dialects. According to the implementation shown in FIG. 1, for example, speech from any of participants 120, 122, 124, 126 or 128 may be received by microphones 132a and/or 132b. The received speech may be routed to processor 140, which may have one or more circuits configured to make the determination of action 460.

Where an implementation utilizes the set of features created by actions 420 through 450 of diagram 400, for example, addressee identification of participant speech during a particular time interval may be made independent of speech recognition while focusing on only that particular time interval of each of the participants' behavior, lasting for example, 500 milliseconds. Where an implementation utilizes the set of features created by actions 420 through 460 of diagram 400, for example, consideration of the effect of accurate speech recognition over a small, task-independent vocabulary on addressee identification of participant speech may also be incorporated.

Continuing with action 470 of diagram 400, action 470 includes assigning a first addressing status to each participant during the particular time interval, based on the set of features for each of the participants determined during the particular time interval. Thus, the implementations discussed thus far utilize only the first function evaluation, which analyzes only the particular time interval for which the classification is being made, to classify and identify each participant as addressing speech to an automated character during that particular time interval.

However, each of the above mentioned determinations may be more useful when considered over several time intervals. Thus, an alternative implementation builds on the implementations discussed above by applying a second function evaluation, in addition to the first function evaluation, within the method for assignee identification of speech. The second function evaluation may be configured to assign a second addressing status to a particular time interval utilizing results of the first function evaluation for that particular time interval and for one or more additional contiguous time intervals.

The arrangement of the one or more additional contiguous time intervals may vary according to the needs of a particular application. For example, in one specific application the second function evaluation may utilize results from the time interval being classified as well as one immediately prior time interval and two immediately following time intervals. In another specific application, the second function evaluation may utilize results from the time interval being classified as well as one immediately prior time interval and one immediately following time interval.

Referring back to FIG. 2, flowchart 200 illustrates the application of such a second function evaluation. Action 230 includes applying a second function evaluation. According to the implementation shown in FIG. 1, for example, processor 140 may have one or more circuits configured to apply the second function to each participant during each of the plurality of time intervals in succession. An example of time intervals considered by such a second function evaluation are illustrated as time intervals 310 through 340 of FIG. 3, for example. In the example shown by FIG. 3, the second addressing status for time interval 320, for example, may be calculated based on the first function evaluation having already calculated a first addressing status for each of the participants during each of time intervals 310 through 340, for example.

Such an implementation is further illustrated by FIG. 5. For example, blocks 510 through 540 may correspond to the results of the first function evaluation applied to each of the participants during time intervals 310 through 340 of FIG. 3, respectively. Such results may include the set of features for each of the participants during a particular time interval or, in the alterative, may include only the first addressing status for that particular time interval. Block 550 includes assigning a second addressing status to each participant during a particular time interval utilizing results of the first function evaluation for the particular time interval and for one or more additional contiguous time intervals. In the example of FIG. 5, the particular time interval may correspond to block 520, while the results of block 510 correspond to an immediately prior time interval, for example. The results of blocks 530 and 540 may then correspond to two immediately following time intervals, for example.

Thus, according to the this implementation, the classification of a particular time interval as containing participant speech addressed to an automated character or not may be delayed from real-time according to the number of time intervals immediately following the particular time interval which are utilized by the second function evaluation.

Once the first and second function evaluations have been applied, each participant may be classified as addressing speech to an automated character or not addressing speech to the automated character during each time interval. Action 240 of flowchart 200 includes classifying each of the plurality of participants as addressing speech to an automated character or not addressing speech to an automated character during each of the plurality of time intervals. According to the implementation shown in FIG. 1, for example, processor 140 may have one or more circuits configured to classify each of the plurality of participants as addressing speech to an automated character or not addressing speech to an automated character during each of the plurality of time intervals. Where only the first function evaluation is applied in classifying each time interval, action 240 may immediately follow action 220. Thus, the present application, according to various implementations, provides a method and associated system which is capable of identifying when an automated character is being spoken to rather than another participant in a small group of children, or children and adults.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the spirit and the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A method for addressee identification of speech, said method comprising:
dividing participation of each of a plurality of participants into a plurality of time intervals;
utilizing one or more function evaluations to classify each of said plurality of participants as addressing speech to an automated character or not addressing speech to said automated character during each of said plurality of time intervals.

2. The method of claim 1, wherein a first function evaluation of said one or more function evaluations comprises:
computing values for a predetermined set of features for each of said plurality of participants during a particular time interval;
assigning a first addressing status to each of said plurality of participants in said particular time interval, based on said predetermined set of features for each of said plurality of participants determined during said particular time interval.

3. The method of claim 2, wherein said predetermined set of features for a particular participant during said particular time interval comprises one or more of:
a determination of whether said particular participant is speaking during said particular time interval;
a determination of whether said automated character prompted for a response from said plurality of participants during said particular time interval;
a determination of whether gestures or head movements of said particular participant are present during said particular time interval;
a determination of a pitch of said participant speech and a volume of said particular participant's speech, each averaged over said particular time interval;
a determination of whether said participant speech includes one or more discourse markers, utilizing speech recognition.

4. The method of claim 1, wherein a second function evaluation of said one or more function evaluations is configured to assign a second addressing status to each of said plurality of participants in a particular time interval utilizing results of said first function evaluation for said particular time interval and for one or more additional contiguous time intervals.

5. The method of claim 3, wherein said gestures comprise one or more of a head shake yes, a head shake no, pointing gestures and emphasis gestures; and
said head movements comprise one of a head turn away from said automated character, a head turn toward said automated character, and an inclined head.

6. The method of claim 3, wherein said discourse markers comprise one or more of the words “um”, “ok”, “who”, “what”, “when”, “where”, “why” and words having an equivalent meaning in English and a non-English language.

7. The method of claim 1, wherein said automated character is a computer-controlled automated character or robot.

8. The method of claim 1, wherein each of said plurality of time intervals is 500 milliseconds in duration.

9. The method of claim 1, wherein said plurality of participants comprise children.

10. The method of claim 1, wherein said plurality of participants comprise one or more children and one or more adults.

11. A system for addressee identification of speech, said system comprising:
one or more circuits configured to:
divide participation of each of a plurality of participants into a plurality of time intervals;
utilize one or more function evaluations to classify each of said plurality of participants as addressing speech to an automated character or not addressing speech to said automated character during each of said plurality of time intervals.

12. The system of claim 1, wherein a first function evaluation of said one or more function evaluations comprises:
computing values for a predetermined set of features for each of said plurality of participants during a particular time interval;
assigning a first addressing status to each of said plurality of participants in said particular time interval, based on said predetermined set of features for each of said plurality of participants determined during said particular time interval.

13. The system of claim 12, wherein said predetermined set of features for a particular participant during said particular time interval comprises one or more of:
a determination of whether said particular participant is speaking during said particular time interval;
a determination of whether said automated character prompted for a response from said plurality of participants during said particular time interval;
a determination of whether gestures or head movements of said particular participant are present during said particular time interval;
a determination of a pitch of said participant speech and a volume of said particular participant's speech, each averaged over said particular time interval;
a determination of whether said participant speech includes one or more discourse markers, utilizing speech recognition.

14. The system of claim 11, wherein a second function evaluation of said one or more function evaluations is configured to assign a second addressing status to each of said plurality of participants in a particular time interval utilizing results of said first function evaluation for said particular time interval and for one or more additional contiguous time intervals.

15. The system of claim 13, wherein said gestures comprise one or more of a head shake yes, a head shake no, pointing gestures and emphasis gestures; and
said head movements comprise one of a head turn away from said automated character, a head turn toward said automated character, and an inclined head.

16. The system of claim 13, wherein said discourse markers comprise one or more of the words “um”, “ok”, “who”, “what”, “when”, “where”, “why” and words having an equivalent meaning in English and in a non-English language.

17. The system of claim 11, wherein said automated character is a computer-controlled automated character or robot.

18. The system of claim 11, wherein each of said plurality of time intervals is 500 milliseconds in duration.

19. The system of claim 11, wherein said plurality of participants comprise children.

20. The system of claim 1, wherein said plurality of participants comprise one or more children and one or more adults.
